(19) United States
(12) Patent Application Publication
(10) Pub. No.: US 2016/0129575 A1
(43) Pub. Date: May 12, 2016

(54) METHOD FOR CONTROLLING A PERCUSSION TOOL POWER SUPPLY PARAMETER

(71) Applicant: MONTABERT, Saint-Priest (FR)

(72) Inventor: Jean-Sylvain COMARMOND, Vourles (FR)

(21) Appl. No.: 14/898,376

(22) PCT Filed: May 22, 2014
(86) PCT No.: PCT/EP2014/060573

§ 371 Date: Dec. 14, 2015

(30) Foreign Application Priority Data
Jun. 12, 2013 (FR) 13/55417

(51) Int. Cl. B25D 9/14; E02F 9/20; E02F 9/24; B25D 17/11; E02F 5/32

(52) U.S. Cl. CPC B25D 9/14; B25D 17/11; E02F 5/323; E02F 9/245; E02F 9/20

(57) ABSTRACT

A control method including providing a control device arranged to adjust a supply parameter of a percussion apparatus, providing a control unit arranged to apply a control instruction to the control device, switching on the percussion apparatus, measuring at least one sound data in the vicinity of a predetermined area, transmitting the at least one measured sound data to the control unit, comparing the at least one sound data received by the control unit with a predetermined threshold value, correcting the control instruction of the control device depending on the at least one received sound data, and applying, by means of the control unit, the corrected control instruction to the control device.

### TECHNICAL FIELD

The present invention concerns a method for controlling a supply parameter of a percussion apparatus actuated by a pressurized incompressible fluid, and an assembly for implementing this method.

### BACKGROUND

A percussion apparatus, called hydraulic rock breaker, is commonly used for various applications, such as quarry blocks breaking, demolition works or trenching. A hydraulic rock breaker includes particularly a striking piston arranged to cyclically strike a tool so as to produce impact energy on the material to be demolished. When using a rock breaker, the latter generates a significant running noise that propagates within the immediate environment of the rock breaker in the form of sound waves likely to induce noise nuisances for people located in the vicinity of the rock breaker.

In order to limit the impact of these noise nuisances, the use of a rock breaker can be limited, even forbidden, below a minimum distance around sensitive areas, that is to say around areas inhabited or occupied by third parties, such as residential areas, areas of industrial, commercial or agricultural activities, or even education, care or rest areas.

Furthermore, the choice of a rock breaker model can be conditioned by the type of work to be performed. For example, when work must be carried out in the vicinity of sensitive areas, it may be necessary to select a low-powered rock breaker to limit the noise nuisances.

These noise nuisances can be significantly variable, particularly in urbanized environment, due to the field variability, thus to the materials absorption coefficients, and due to the site configuration with possible reflections of the sound waves on buildings or neighboring structures. As a result, it is very difficult to predict the sound levels perceived within a predetermined area located in the vicinity of the rock breaker.

Under these conditions, the variability of these noise nuisances makes the use of rock breaker particularly delicate. To overcome this problem, it is common for a project manager to impose the use of a very low-powered rock breaker, the speed of execution of work is then slow and the costs of work become significant.

To overcome this drawback, it is known to record, for the whole duration of the work carried out in the vicinity of sensitive areas, the sound levels of sound waves propagating in the vicinity of these sensitive areas, thanks to the use of a detection system particularly comprising one or more microphone(s) and a recorder arranged to check the sound levels measured by the microphone(s).

Thus, the rock breaker operator can be informed of the noise nuisance he caused on the environment, and he may if necessary replace the rock breaker used by a lower-powered model of rock breakers.

In all cases, the use of a rock breaker in the vicinity of sensitive areas remains subject to human error, and it is common that the maximum permissible sound levels are exceeded.

### BRIEF SUMMARY

The present invention aims to remedy these drawbacks by providing a control method and an assembly for its implementation, allowing to limit the noise nuisances generated during the work accomplishment using a percussion apparatus, below a maximum permissible value.

To this end, the present invention concerns a control method for controlling a supply parameter of a percussion apparatus actuated by a pressurized incompressible fluid, characterized in that it comprises the following steps:
providing a control device arranged to adjust a supply parameter of the percussion apparatus,
providing a control unit arranged to apply a control instruction to the control device,
switching on the percussion apparatus,
measuring at least one sound data in the vicinity of a predetermined area,
transmitting the at least one measured sound data to the control unit,
comparing the at least one sound data received by the control unit with a predetermined threshold value,
correcting the control instruction of the control device depending on the at least one received sound data, and
applying, by means of the control unit, said corrected control instruction to the control device so as to adjust the supply parameter of the percussion apparatus depending on the measured sound data.

Thus, the control method according to the invention allows adjusting automatically, via the control unit and the control device, a supply parameter, such as the supply flow rate or the supply pressure, of the percussion apparatus depending on the measured sound data in the vicinity of the predetermined area. These dispositions allow optimizing the operation of the percussion apparatus, while avoiding that the sound levels of the sound waves generated by the percussion apparatus and propagating in the vicinity of sensitive areas do not exceed the predetermined threshold value.

According to one mode of implementation of the control method, the predetermined area is an area inhabited or occupied by third parties, such as a residential area, an area of industrial, commercial or agricultural activities, or even an education, care or rest area.

According to one mode of implementation of the invention, the predetermined area is moved relative to the percussion apparatus.

According to one mode of implementation of the control method, the control instruction is corrected such that the supply parameter adjusted by the control device induces sound data, advantageously in the vicinity of the predetermined area, lower than the predetermined threshold value.

According to one mode of implementation of the control method, the control instruction is corrected taking into account the predetermined threshold value.

According to one mode of implementation of the control method, the latter comprises iteratively repeating the measurement, transmission, comparison, correction and application steps.

According to one mode of implementation of the control method, the latter comprises setting, particularly by an operator input, the predetermined threshold value. These dispositions allow adapting the predetermined threshold value depending on the predetermined area to be protected.

According to one mode of implementation of the control method, if the at least one received sound data is greater than the predetermined threshold value, the correction step comprises correcting the control instruction of the control device so as to decrease the supply parameter of the percussion apparatus.

According to one mode of implementation of the control method, if the at least one received sound data is lower than the predetermined threshold value, the correction step comprises correcting the control instruction of the control device so as to increase the supply parameter of the percussion apparatus.

According to one mode of implementation of the control method, if the at least one received sound data is lower than the predetermined threshold value and if the difference between the at least one received sound data and the predetermined threshold value is greater than a predetermined limit value, the correction step comprises correcting the control instruction of the control device so as to increase the supply parameter of the percussion apparatus.

According to one mode of implementation of the control method, if the at least one received sound data is lower than the predetermined threshold value and if the difference between the at least one received sound data and the predetermined threshold value is lower than the predetermined limit value, the correction step comprises maintaining the value of the previously applied control instruction.

According to one mode of implementation, the control method comprises a interrupting the supply of the pressurized incompressible fluid to the percussion apparatus when the at least one sound data received by the control unit is greater than the predetermined threshold value and when simultaneously the supply parameter of the percussion apparatus is adjusted to its minimum by the control device. These dispositions allow automatically interrupting the supply of the pressurized incompressible fluid to the percussion apparatus so as to protect the predetermined area from the sound waves produced by the percussion apparatus. In such case, the operator must for example take the percussion apparatus away from the predetermined area before restarting said percussion apparatus.

According to one mode of implementation of the invention, the measurement step comprises measuring the sound level of the sound waves propagating in the vicinity of the predetermined area.

According to one mode of implementation of the control method, the latter comprises providing means for measuring sound data in the vicinity of the predetermined area.

According to one mode of implementation of the invention, the measurement step is carried out with one or more microphone(s) disposed in the vicinity of the predetermined area.

According to one mode of implementation, the control device is arranged to adjust, for example stepwise or continuously, the supply parameter of the percussion apparatus between a minimum value and a maximum value. According to one mode of implementation, the control device is arranged to adjust the supply parameter of the percussion apparatus in different values comprised between the minimum and maximum values.

According to one mode of implementation, the control method comprises moving a control member comprised in the control device between a first control position corresponding to a maximum value of the supply parameter and a second control position corresponding to a minimum value of the supply parameter.

According to one mode of implementation of the control method, the control instruction initially applied to the control device, that is to say, upon switching-on the percussion apparatus, is determined so as to adjust the supply parameter to a minimum value.

According to one mode of implementation of the control method, the step of moving the control member is carried out continuously or stepwise.

According to one mode of implementation of the control method, the latter comprises determining the predetermined area and of providing means for measuring the sound data in the vicinity of the predetermined area.

The present invention further concerns an assembly comprising:
a percussion apparatus actuated by a pressurized incompressible fluid, including a striking piston arranged to strike a tool during each operating cycle of the percussion apparatus,
a control device arranged to adjust a supply parameter of the percussion apparatus,
a control unit arranged to apply a control instruction to the control device,
sound data measuring means intended to be disposed in the vicinity of a predetermined area,
transmission means connected to the sound data measuring means and arranged to transmit the sound data measured by the measuring means,

the control unit being arranged to:
receive the sound data transmitted by the transmission means,
compare the received sound data with a predetermined threshold value,
correct the control instruction of the control device depending on the received sound data, and
apply said corrected control instruction to the control device so as to adjust the supply parameter of the percussion apparatus depending on the received sound data.

According to one embodiment of the invention, the predetermined area is an area inhabited or occupied by third parties, such as a residential area, an area of industrial, commercial or agricultural activities, or an education, care or rest area.

According to one embodiment of the invention, the control unit is arranged to correct the control instruction such that the supply parameter adjusted by the control device induces sound data, advantageously in the vicinity of the predetermined area, lower than the predetermined threshold value.

According to one embodiment of the invention, when the sound data received by the control unit are greater than the predetermined threshold value, the control unit is arranged to correct the control instruction of the control device so as to decrease the supply parameter.

According to one embodiment of the invention, when the sound data received by the control unit are lower than the predetermined threshold value, the control unit is arranged to correct the control instruction of the control device so as to increase the supply parameter.

According to one embodiment of the invention, when the sound data received by the control unit are lower than the predetermined threshold value and when simultaneously the difference between the received sound data and the predetermined threshold value is greater than a predetermined limit value, the control unit is arranged to correct the control instruction of the control device so as to increase the supply parameter.

According to one embodiment of the invention, the assembly comprises a high-pressure supply circuit intended to supply the pressurized incompressible fluid to the percussion apparatus, and a low-pressure return circuit.

According to one embodiment of the invention, the percussion apparatus comprises a body delimiting a cylinder in which the striking piston is movably mounted in an alternative manner.

For example, the striking piston and the cylinder delimit at least one lower chamber permanently connected to the high-pressure supply circuit and an upper chamber alternately linked to the high-pressure supply circuit and the low-pressure return circuit.

According to one feature of the invention, the control unit is arranged to control the supply interruption of the pressurized incompressible fluid to the percussion apparatus when the sound data received by the control unit are greater than the predetermined threshold value and when simultaneously the supply parameter is adjusted to its minimum by the control device.

According to one embodiment of the invention, the assembly comprises a blocking device arranged to block the high-pressure supply circuit.

According to one embodiment of the invention, the blocking device is mounted on the high-pressure supply circuit.

According to one embodiment of the invention, the blocking device comprises a movable blocking member between a blocking position wherein said blocking member blocks the high-pressure supply circuit, and a release position wherein said blocking member releases the high-pressure supply circuit.

According to one embodiment of the invention, the control unit is arranged to control the movement of the blocking member between its blocking and release positions.

According to one embodiment of the invention, the blocking device comprises an actuating element arranged to move the blocking member between its blocking and release positions.

According to one embodiment of the invention, the actuating element is arranged to receive a control instruction from the control unit, and to move the blocking member depending on the control instruction.

According to one embodiment of the invention, the blocking device is a solenoid valve, and for example an on-off solenoid valve, such as a normally open solenoid valve or a normally closed solenoid valve.

According to one embodiment of the invention, the measurement means are arranged to measure the sound levels of the sound waves propagating in the vicinity of the predetermined area.

According to one feature of the invention, the measurement means include one or more microphone(s) intended to be disposed in the vicinity of the predetermined area.

According to one feature of the invention, the control device comprises a control member movable between a first control position corresponding to a maximum value of the supply parameter and a second control position corresponding to a minimum value of the supply parameter.

According to one embodiment of the invention, the control device is external to the percussion apparatus.

According to one embodiment of the invention, the control device is hydraulic.

According to one embodiment of the invention, the control unit is arranged to control the movement of the control member between its first and second positions, and for example continuously or stepwise.

According to one embodiment of the invention, the control device is provided so with an actuating member arranged to move the control member between its first and second control positions.

According to one embodiment of the invention, the actuating member is arranged to receive the corrected control instruction from the control unit, and to move the control member depending on the corrected control instruction.

According to one embodiment of the invention, the control device comprises a pressure regulator, and for example a proportional control-type pressure regulator.

According to one embodiment of the invention, the control device is mounted on the high-pressure supply circuit.

According to one feature of the invention, the control device is arranged to adjust the supply pressure, also called operating pressure, of the percussion apparatus between a minimum supply pressure and a maximum supply pressure.

According to one embodiment of the invention, the control device is arranged to adjust continuously or stepwise the supply pressure of the percussion apparatus between the minimum and maximum supply pressures.

According to one embodiment of the invention, the control unit is arranged to correct the control instruction of the control device so as to decrease the supply pressure of the percussion apparatus when the sound data received by the control unit are greater than the predetermined threshold value.

According to one embodiment of the invention, the control unit is arranged to correct the control instruction of the control device so as to increase the supply pressure of the percussion apparatus when the sound data received by the control unit are lower than the predetermined threshold value.

According to one embodiment of the invention, the control device comprises a flow rate regulator, and for example a proportional control-type flow rate regulator.

According to one embodiment of the invention, the control device is arranged to adjust the supply flow rate of the percussion apparatus between a minimum supply flow rate and a maximum supply flow rate.

According to one embodiment of the invention, the control device is arranged to adjust continuously or stepwise the supply flow rate of the percussion apparatus between the minimum and maximum supply flow rates.

According to one embodiment of the invention, the control unit is arranged to correct the control instruction of the control device so as to decrease the supply flow rate of the percussion apparatus when the sound data received by the control unit so are greater than the predetermined threshold value.

According to one embodiment of the invention, the control unit is arranged to correct the control instruction of the control device so as to increase the supply flow rate of the percussion apparatus when the sound data received by the control unit are lower than the predetermined threshold value.

According to one embodiment of the invention, the assembly comprises a variable displacement supply pump connected to the high-pressure supply circuit, and the control device is arranged to adjust the displacement of the supply pump between a minimum displacement and a maximum displacement.

According to one embodiment of the invention, the control unit and the percussion apparatus are intended to be mounted on a carrier machine, such as a hydraulic shovel.

According to one embodiment of the invention, the assembly comprises setting means arranged to set, particularly by an operator input, the predetermined threshold value.

According to one embodiment of the invention, the control unit includes a receiver arranged to receive the sound data transmitted by the transmission means.

### BRIEF DESCRIPTION OF THE DRAWINGS

Anyway, the invention will be better understood using the following description with reference to the appended schematic drawing showing, by way of non-limiting examples, three embodiments of this assembly.

FIG. 1 is a schematic view of an assembly according to a first embodiment of the invention.

FIG. 2 is a schematic view of an assembly according to a second embodiment of the invention.

FIG. 3 is a schematic view of an assembly according to a third embodiment of the invention.

FIG. 4 is a schematic view of an assembly according to a fourth embodiment of the invention.

### DETAILED DESCRIPTION

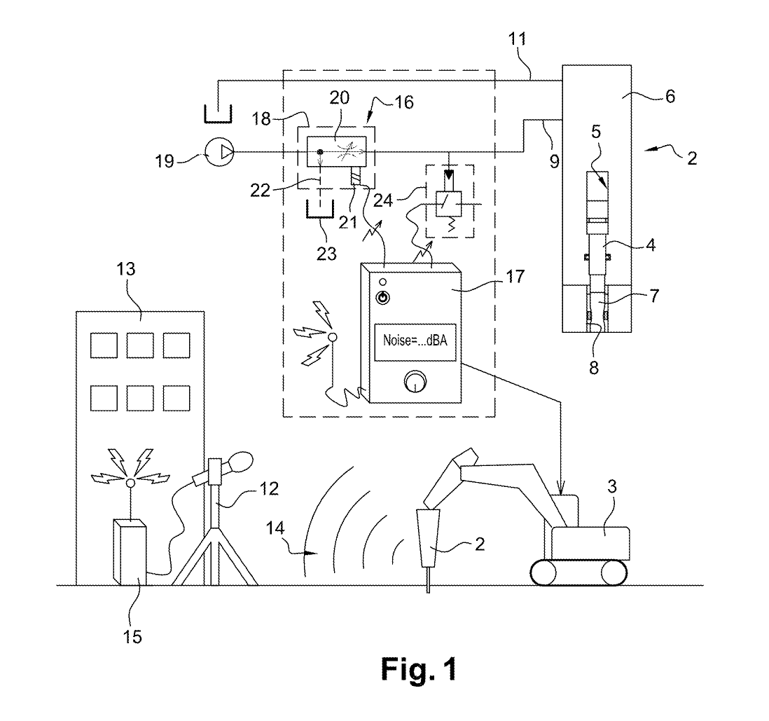

FIG. 1 shows an assembly according to a first embodiment of the invention comprising a percussion apparatus 2, such as a hydraulic rock breaker, mounted on a carrier machine 3, such as a hydraulic shovel.

The percussion apparatus 2 comprises a stepped striking piston 4 slidably mounted in an alternative manner within a cylinder 5 arranged in a body 6 of the percussion apparatus 2. During each operating cycle of the percussion apparatus 2, the striking piston 4 strikes the upper end of a tool 7 slidably mounted in a bore 8 arranged in the body 3 coaxially to the cylinder 5. The striking piston 4 and the cylinder 5 delimit for example a lower chamber (not shown in the figures) fluidly connected permanently to a high-pressure supply circuit 9 intended to supply the pressurized incompressible fluid to the percussion apparatus 2 and an upper chamber (not shown in the figures) with a more significant section arranged above the striking piston 4.

The percussion apparatus 2 further comprises a distributor (not shown in the figures) mounted in the body 6 and arranged to alternately link the upper chamber to the high-pressure supply circuit 9, during the striking stroke of the striking piston 4, and with a low-pressure return circuit 11 during the rising stroke of the striking piston 4.

The assembly further comprises at least one microphone 12 intended to be disposed in the vicinity of an area to be protected 13 such as a building inhabited or occupied by third parties, so as to measure sound data, such as the sound level, related to sound waves 14 propagating in the vicinity of the area 13 and generated by the operation of the percussion apparatus 2. According to one embodiment of the invention, the assembly may comprise several microphones 12.

The assembly also comprises a transmitter 15 connected to the microphone 12, and arranged to transmit the sound data measured by the microphone 12. The transmitter 15 is preferably disposed in the vicinity of the microphone 12, and thus of the area to be protected 13.

The assembly further comprises a control device 16 external to the percussion apparatus 2 and arranged to adjust the supply flow rate of the percussion apparatus 2, and a control unit 17 arranged to apply a control instruction to the control device 16.

According to the embodiment shown in FIG. 1, the control device 16 is hydraulic and formed by a proportional control flow rate regulator 18 mounted on the high-pressure supply circuit 9 downstream of a supply pump 19 disposed on the carrier machine 3.

The flow rate regulator 18 comprises a control member 20 movable between a first control position corresponding to a maximum supply flow rate of the percussion apparatus 2 and a second control position corresponding to a minimum supply flow rate of the percussion apparatus 2. The flow rate regulator 18 further comprises an actuating coil 21 arranged to receive the control instruction from the control unit 17, and to move the control member 20 between its first and second control positions depending on the received control instruction.

The assembly further comprises a return line 22 fluidly connected on the one hand to a low-pressure tank 23 and on the other hand to the flow rate regulator 18. The return line 22 and the upstream and downstream portions of the high-pressure supply circuit 9 advantageously open into a cylinder (not shown in the figures) in which the control member 20 is slidably mounted.

The flow rate regulator 18 is particularly arranged to deviate towards the return line 22, a more or less significant part of the fluid flow rate provided by the supply pump 19 depending on the position of the control member 20, and thus of the control instruction applied to the actuating coil 21 by the control unit 17.

The control unit 17 is arranged to:
receive the sound data transmitted by the transmitter 15.
compare the received sound data with a predetermined threshold value,
correct the control instruction of the control device 16 depending on the received sound data, and
apply the corrected control instruction to the control device 16 so as to adjust the supply flow rate of the percussion apparatus 2.

The control unit 17 is more particularly arranged to:
correct the control instruction of the control device 16 so as to decrease the supply flow rate of the percussion apparatus 2 when the sound data received by the control unit 17 are greater than the predetermined threshold value, and
correct the control instruction of the control device 16 so as to increase the supply flow rate of the percussion apparatus 2 when the sound data received by the control unit 17 are lower than the predetermined threshold value.

Thus, when the percussion apparatus 2 is operating, the sound levels values, or the maximum of these sound levels values, sound waves 14 generated by the percussion apparatus 2 and propagating in the vicinity of the area 13 are measured by the microphones 12 and transmitted by the transmitter 15 to the control unit 17. These values are then compared to the predetermined threshold value. When these values exceed the predetermined threshold value, then the control unit 17 applies a control instruction to the control device 16 so as to decrease the supply flow rate of the percussion apparatus 2, and thus the percussion apparatus power, and this in order to limit the noise nuisances generated by the percussion apparatus. On the contrary, when these values are lower than the predetermined threshold value, then the control unit 17 applies a control instruction to the control device 16 so as to increase the supply flow rate of the percussion apparatus 2 so as to increase the percussion apparatus power, and this in order to optimize the operation of the percussion apparatus 2 without exceeding the maximum permissible sound values within the sensitive area to be protected.

According to the embodiment shown in FIG. 1, the assembly also comprises a pressure switch 24 arranged to measure the pressure in the high-pressure supply circuit 9. The pressure switch 24 is advantageously connected to the control unit 17 so as to transmit to the latter the measured pressure values.

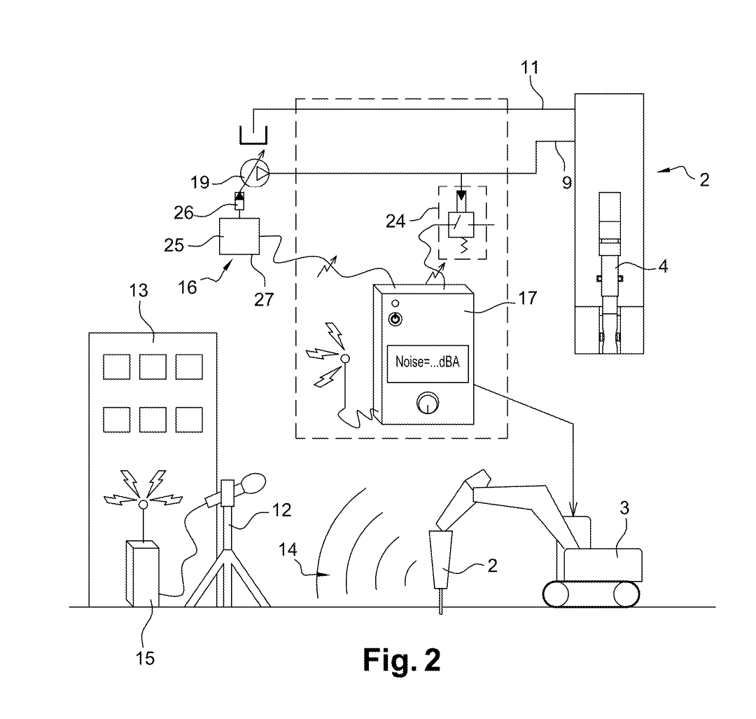

FIG. 2 shows an assembly according to a second embodiment of the invention which differs from the assembly shown in FIG. 1 mainly in that the supply pump 19 is a variable displacement pump, and in that the control device 16 is formed by a control device 25 arranged to adjust the displacement of the supply pump 19 between a minimum displacement and a maximum displacement. The control device 25 is thus arranged to adjust, via the supply pump 19, the supply flow rate of the percussion apparatus 2 between a minimum supply flow rate and a maximum supply flow rate.

The control device 25 comprises a control member 26, such as an actuator, arranged to cooperate with the supply pump 19 and movable between a first control position corresponding to a maximum supply flow rate of the percussion apparatus 2 and a second control position corresponding to a minimum supply flow rate of the percussion apparatus 2.

The control device 25 further comprises a control unit 27 arranged to receive the control instruction from the control unit 17, and to move the control member 26 between its first and second control positions depending on the received control instruction.

According to this embodiment of the invention, the control unit 17 is arranged to:
correct the control instruction of the control device 16 so as to decrease the displacement of the supply pump 19, and thus the supply flow rate of the percussion apparatus 2, when the sound data received by the control unit 17 are greater than the predetermined threshold value, and
correct the control instruction of the control device 16 so as to increase the displacement of the supply pump 19, and thus the supply flow rate of the percussion apparatus 2, when the sound data received by the control unit 17 are lower than the predetermined threshold value.

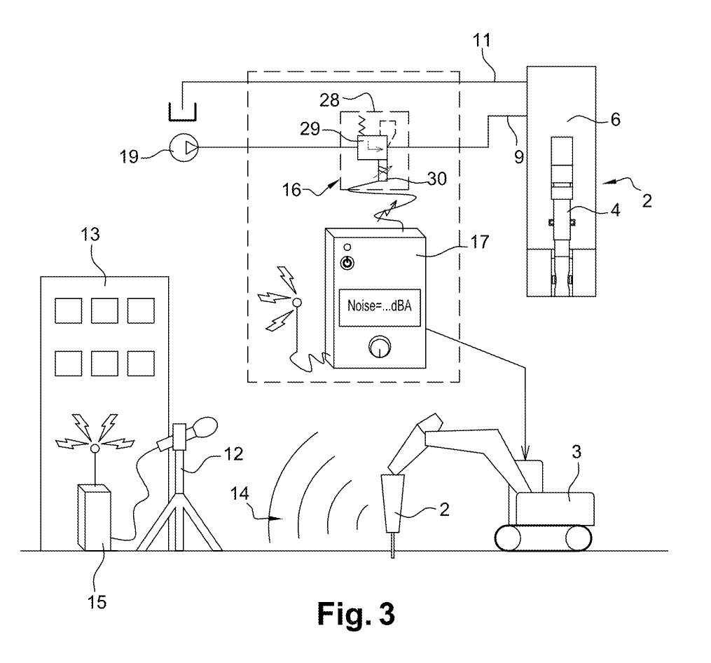

FIG. 3 shows an assembly according to a third embodiment of the invention which differs from the assembly shown in FIG. 1 mainly in that the control device 16 is formed by a proportional control pressure regulator 28 mounted on the high-pressure supply circuit 9, and arranged to adjust the supply pressure of the percussion apparatus 2 between a minimum supply pressure and a maximum supply pressure.

The pressure regulator 28 comprises a control member 29 movable between a first control position corresponding to the maximum supply pressure of the percussion apparatus 2 and a second control position corresponding to the minimum supply pressure of the percussion apparatus 2. The pressure regulator 28 further comprises an actuating coil 30 arranged to receive the control instruction from the control unit 17, and to move the control member 29 between its first and second control positions depending on the received control instruction.

According to this embodiment of the invention, the control unit 17 is arranged to:
correct the control instruction of the control device 16 so as to decrease the supply pressure of the percussion apparatus 2 when the sound data received by the control unit 17 are greater than the predetermined threshold value, and
correct the control instruction of the control device 16 so as to increase the supply pressure of the percussion apparatus 2 when the sound data received by the control unit 17 are lower than the predetermined threshold value.

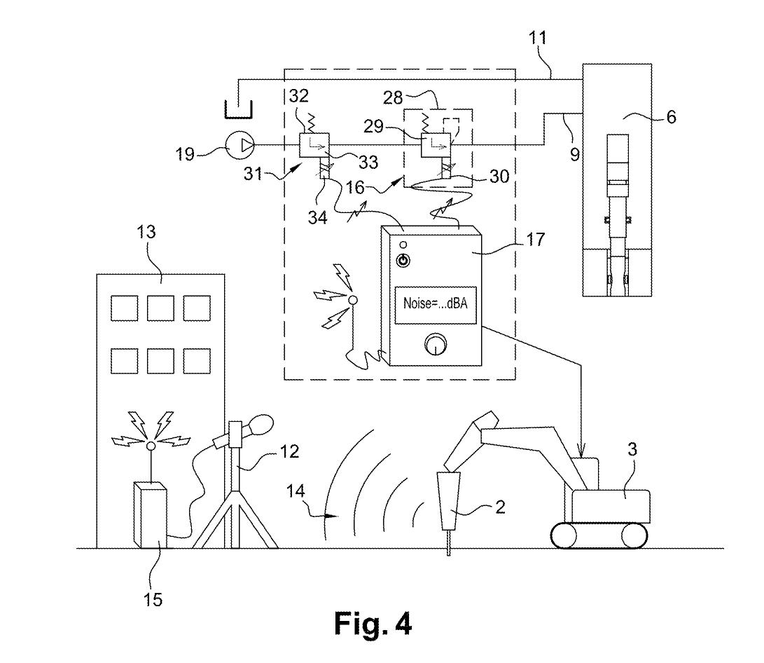

FIG. 4 shows an assembly according to a fourth embodiment of the invention which differs from the assembly shown in FIG. 3 mainly in that the control unit 17 is arranged to control the interruption of the supply of the pressurized incompressible fluid to the percussion apparatus 2 when the sound data received by the control unit 17 are greater than the predetermined threshold value and when simultaneously the supply pressure of the percussion apparatus 2 is adjusted to its minimum by the control device 16.

According to the embodiment shown in FIG. 4, the assembly comprises a blocking device 31 mounted on the high-pressure supply circuit 9, and arranged to block the high-pressure supply circuit 9. The blocking device 31 is for example disposed between the supply pump 19 and the control device 16.

The blocking device 31 is advantageously formed by a solenoid valve 32 and for example an on-off solenoid valve, such as a normally open solenoid valve or a normally closed solenoid valve.

The solenoid valve 32 advantageously comprises a blocking member 33 movable between a blocking position wherein the blocking member 33 blocks the high-pressure supply circuit 9, and a release position wherein the blocking member 33 releases the high-pressure supply circuit 9. The solenoid valve 32 further comprises an actuating coil 34 arranged to receive a control instruction from the control unit 17, and to move the blocking member 33 between its blocking and release positions depending on the received control instruction.

Thus, when the supply pressure of the percussion apparatus is adjusted to its minimum by the control device 16, and when simultaneously the sound data received by the control unit 17 are greater than the predetermined threshold value, the control unit 17 applies a control instruction to the solenoid valve 32, and particularly to its actuating coil 34 so as to control movement of the blocking member 33 towards its blocking position. These dispositions allow automatically interrupting the supply of the pressurized incompressible fluid to the percussion apparatus 2, and then protecting the area 13 of the sound waves produced by the percussion apparatus 2.

According to variant of the invention, the blocking device 31 could be integrated with the assemblies according to the invention shown in FIGS. 1 and 2. In this case, the control unit 17 would be arranged to control interruption of the supply of pressurized incompressible fluid to the percussion apparatus 2 when the sound data received by the control unit 17 are greater than the predetermined threshold value and when simultaneously the supply flow rate of the percussion apparatus 2 is adjusted to its minimum by the control device 16.

It goes without saying that the invention is not limited to the sole embodiments of this assembly, described above as example, it encompasses on the contrary all the variants.

1. A control method for controlling a supply parameter of a percussion apparatus actuated by a pressurized incompressible fluid, comprising:
providing a control device arranged to adjust a supply parameter of the percussion apparatus,
providing a control unit arranged to apply a control instruction to the control device,
switching on the percussion apparatus
measuring at least one sound data in the vicinity of a predetermined area,
transmitting the at least one measured sound data to the control unit
comparing the at least one sound data received by the control unit with a predetermined threshold value,
correcting the control instruction of the control device depending on the at least one received sound data, and
applying, by means of the control unit, said corrected control instruction to the control device.

2. The control method according to claim 1, wherein the correction step comprises correcting the control instruction such that the supply parameter adjusted by the control device induces sound data lower than the predetermined threshold value.

3. The control method according to claim 1, wherein:
if the at least one received sound data is greater than the predetermined threshold value, the correction step comprises correcting the control instruction of the control device so as to decrease the supply parameter of the percussion apparatus.

4. The control method according to claim 1, wherein:
if at least one received sound data is lower than the predetermined threshold value, the correction step comprises correcting the control instruction of the control device so as to increase the supply parameter of the percussion apparatus.

5. The control method according to claim 1, which comprises interrupting the supply of the pressurized incompressible fluid to the percussion apparatus when the at least one sound data received by the control unit is greater than the predetermined threshold value and when simultaneously the supply parameter of the percussion apparatus is adjusted to its minimum by the control device.

6. The control method according to claim 1, which comprises moving a control member comprised by the control device between a first control position corresponding to a maximum value of the supply parameter of the percussion apparatus and a second control position corresponding to a minimum value of the supply parameter of the percussion apparatus.

7. The control method according to claim 1, which comprises iteratively repeating the measurement, transmission, comparison, correction and application steps.

8. The control method according to claim 1, wherein the predetermined area is an area inhabited or occupied by third parties.

9. An assembly comprising:
a percussion apparatus actuated by a pressurized incompressible fluid, including a striking piston arranged to strike a tool during each operating cycle of the percussion apparatus,
a control device arranged to adjust a supply parameter of the percussion apparatus,
a control unit arranged to apply a control instruction to the control device,
sound data measuring means intended to be disposed in the vicinity of a predetermined area,
transmission means connected to the sound data measuring means, and arranged to transmit the sound data measured by the measuring means,
the control unit being arranged to:
receive the sound data transmitted by the transmission means,
compare the received sound data with a predetermined threshold value,
correct the control instruction of the control device depending on the received sound data, and
apply said corrected control instruction to the control device.

10. The assembly of claim 9, wherein, when the sound data received by the control unit are greater than the predetermined threshold value, the control unit is arranged to correct the control instruction of the control device so as to decrease the supply parameter of the percussion apparatus.

11. The assembly of claim 9, wherein, when the sound data received by the control unit are lower than the predetermined threshold value, the control unit is arranged to correct the control instruction of the control device so as to increase the supply parameter of the percussion apparatus.

12. The Assembly according to claim 9, wherein the control unit is arranged to control the interruption of the supply of the pressurized incompressible fluid to the percussion apparatus when the sound data received by the control unit are greater than the predetermined threshold value and when simultaneously the supply parameter of the percussion apparatus is adjusted to a minimum by the control device.

13. The assembly according to claim 9, wherein the control device comprises a control member movable between a first control position corresponding to a maximum value of the supply parameter and a second control position corresponding to a minimum value of the supply parameter.

14. The assembly according to claim 9, wherein the control device is arranged to adjust the supply flow rate of the percussion apparatus between a minimum supply flow rate and a maximum supply flow rate.

15. The assembly according to claim 9, wherein the control device is arranged to adjust the supply pressure of the percussion apparatus between a minimum supply pressure and a maximum supply pressure.
